(19) United States
(12) Patent Application Publication
(10) Pub. No.: US 2013/0328783 A1
(43) Pub. Date: Dec. 12, 2013

(54) TRANSMISSION OF INFORMATION TO SMART FABRIC OUPUT DEVICE

(71) Applicants: Sheridan Martin, Seattle, WA (US); Alex Aben-Athar Kipman, Redmond, WA (US); Kathryn Stone Perez, Kirkland, WA (US); Bob Crocco, JR., Seattle, WA (US)

(72) Inventors: Sheridan Martin, Seattle, WA (US); Alex Aben-Athar Kipman, Redmond, WA (US); Kathryn Stone Perez, Kirkland, WA (US); Bob Crocco, JR., Seattle, WA (US)

(21) Appl. No.: 13/688,132

(22) Filed: Nov. 28, 2012

Related U.S. Application Data
(63) Continuation of application No. 13/174,286, filed on Jun. 30, 2011, now abandoned.

(51) Int. Cl. G09G 5/00

(52) U.S. Cl. CPC G09G 5/006
USPC 345/169; 345/156

(57) ABSTRACT

A system and method are provided for a user to communicate uniquely human and personal information to one or more other users, via a smart textile input/output device. The information may be displayed on the device associated with the user, on one or more other articles of clothing associated with one or more other users, or on one or more external devices proximate to and associated with a target user. The information may result from a direct input of display information from a source user to a target user or from a third party directed to one or more target users.

### CLAIM OF PRIORITY

This application is a continuation application of co-pending U.S. patent application Ser. No. 13/174,286, entitled “TRANSMISSION OF INFORMATION TO SMART FABRIC OUPUT DEVICE,” by Small et al., filed Jun. 30, 2011, incorporated herein by reference in its entirety.

### BACKGROUND

There are many techniques allowing individuals to express mood, feelings or proximity to other individuals. Many of these methods involve use of electronic devices passing status indicators to physical displays. Various types of displays can be associated with individuals to allow messages to be send to the display directly. One basic example is that of a mobile device, which displays messages directed to the user.

Smart fabrics are textiles that incorporate electronic elements that respond to electronic or physical control inputs. Smart fabrics can be used in fabricating clothing or other display articles. Digital or smart clothing combines clothing with information technology. For example, a smart jacket may incorporate digital devices as part of the clothing. The digital devices may be directly integrated in the clothing so that they are virtually invisible to the public. Smart clothing has many applications. For example, smart clothing may be found in the fields where the need for monitoring and actuation can be of vital importance, such as a medical environment, and/or with vulnerable population groups such as in space travel and the military. However, as experience and familiarity have increased and hence breaking down barriers, the field of application for smart textiles will expand further to accommodate more daily applications.

### SUMMARY

A system and method are provided for a user to communicate uniquely human and personal information to one or more other users via smart textile output device. The information may be displayed on the article of clothing associated with the user, on one or more other articles of clothing associated with one or more other users, or on one or more output devices associate with a target user. The information may be information directly provided from a source user directed to a target user or users, or may be indirect information provided from third parties wishing to convey information to the target users.

One or more actions are determined for the smart textile input/output device based upon the information gathered. Determining one or more actions to be performed based upon the information gathered may include determining a set of one or more rules configured for smart textile input/output device with each rule specifying a condition and an action to be performed when the condition specified in the rule is satisfied, and determining that the condition associated with a first rule from the set of rules is satisfied by the information gathered. At least one action of the one or more actions determined to be performed is the action specified by the first rule. The one or more actions to be determined may be executed on the smart textile input/output device.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A is an example communication system according to an embodiment of the present technology.

FIG. 1B is a simplified method in accordance with the present technology.

FIG. 2 is a simplified block diagram illustrating an example system implemented in an article of clothing according to an embodiment of the present technology

FIG. 3 is an example computing device for implementing the present technology.

FIG. 4 is a simplified flow chart depicting a process according to an embodiment of the present technology.

FIG. 5 is a simplified flow chart depicting a process for detecting and/or gathering information associated with a user according to an embodiment of the present technology.

FIG. 6 is a simplified flow chart depicting a process for evaluating a set of one or more rules to determine one or more actions to be performed according to an embodiment of the present technology.

FIG. 7 is a simplified schematic diagram of an example circuit according to an embodiment of the present technology.

FIG. 8 is a simplified flow chart depicting a process according to an embodiment of the present technology.

FIGS. 9A-9C illustrate exemplary pieces of fabric that may be used to create an article of clothing according to an embodiment of the present technology.

FIGS. 10A-10B illustrate exemplary articles of clothing according to an embodiment of the present technology.

FIG. 11 is a block diagram representing an alternative embodiment of the present technology.

FIG. 12 is a flow chart illustrating the alternative embodiment shown in FIG. 11.

FIGS. 13A and 13B is a depiction of an alternative smart textile output device.

FIG. 14 is a flow chart illustrating the alternative embodiment shown in FIG. 13.

FIGS. 15A and 15B is a depiction of an alternative smart textile output device providing a haptic feedback from a source user to a target user.

### DETAILED DESCRIPTION

The technology described herein provides a system and method that enables a user to communicate an express input or ancillary information to one or more other users using a smart textile input/output device. The device is comprised of a smart fabric which responds to display information by transforming the information to an output expressible by the smart textile device. In one embodiment, the smart textile device may comprise clothing or wearable accessory associated with the user. In another embodiment, the smart textile device may comprise a display article fabricated from a smart fabric. The information may be displayed on an smart textile device associated with a target user, on one or more other devices associated with one or more other target users, or on one or more smart textile devices located near a target user and designed to present information to a target user. The information may convey a message or information from a source, which may be an individual user, a group of users or a third party input provider. In one embodiment, for example, a source user may wish to convey a unique hand shape to a portion of clothing worn by a target user. Other examples include information identifying a drawing created by the user via to be displayed on a target article of clothing or wearable accessory associated with the target user, or contextual information associated with the source user. Third party information may be direct, as in a specific message to a user, or indirect, indicating that target user is in near proximity to a friend, indicating that a target user has not interacted with a social network friend for some time, or indicating that a target user is in close proximity to a special offer proved by a vendor via the system.

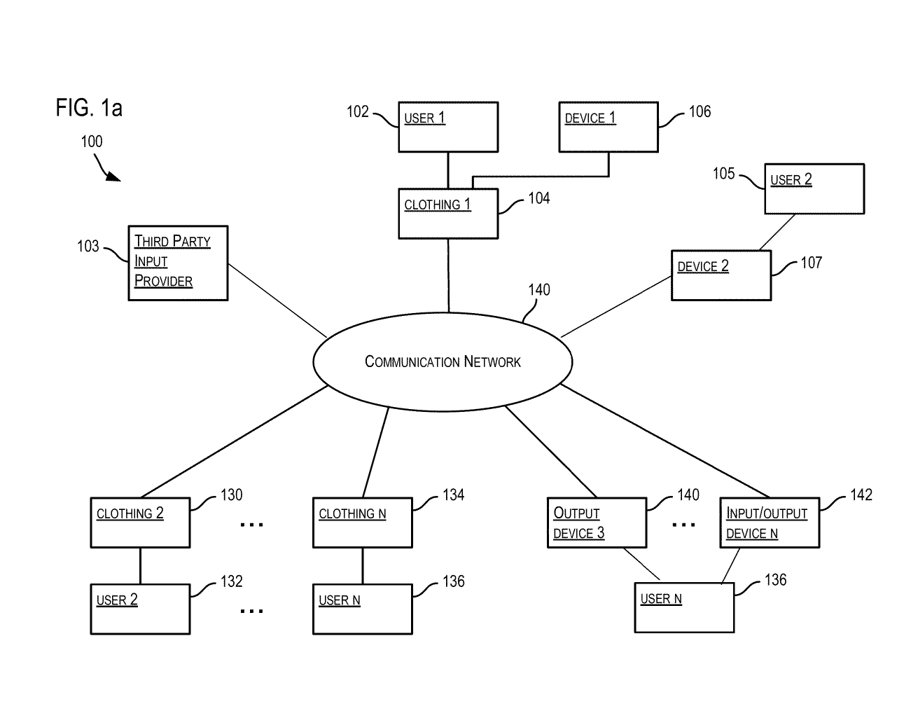

The present technology will now be described in reference to FIGS. 1-14. FIG. 1 is an example communication system 100 according to an embodiment of the present technology.

Referring to FIG. 1, system 100 may include one or more output devices with each device directly or indirectly associated with a user. For example, system 100 may include a first smart textile input/output device comprising article of clothing 104 associated with a first user 102, a second smart textile input/output device comprising article of clothing 130 associated with a second user 132, an nth smart textile input/output device comprising article of clothing 134 associated with an nth user 136, etc. System 100 may also include one or more external output devices such as device 106, device 140, device 142, and so forth. Each of these external devices may or may not be associated with a user. For example, device 106 may be associated with the first user 102, while devices 140 and 142 are standalone devices that are not associated with any users but may be viewed or otherwise interacted with by user N 138. The one or more external devices in system 100 may be any devices such as a smart phone, a personal digital assistant (PDA), a microphone, a positioning device, a camera, etc, or devices constructed from a smart textile, as described herein. System 100 may further include a network 140. Network 140 may be implemented as the Internet, a WAN, a LAN, intranet, extranet, private network, or other types of network or networks.

Throughout this document, an article of clothing is interpreted broadly to include a garment or wearable accessory embedded therein at least one integrated electronic device and/or one or more conductive threads for implementing the present technology as will be described below. For example, an article of clothing may be a jacket, a T-shirt, a scarf, an article of jewelry (e.g., a necklace, a bracelet, a ring), a dog collar, and the like. Alternatively, an article of clothing may be an article of fabric that can be configured into various garment types, shapes, and sizes. “User” may be interpreted broadly to include both humans and non-humans associated with an article of clothing embedded therein at least one integrated electronic devices and/or one or more conductive threads for implementing the present technology. The term “button” is used to refer to a specific location on an article of clothing. For example, when a user presses down on an article of clothing, one or more “buttons” are pressed. That is, one or more locations on the surface of the clothing have been pressed by the user.

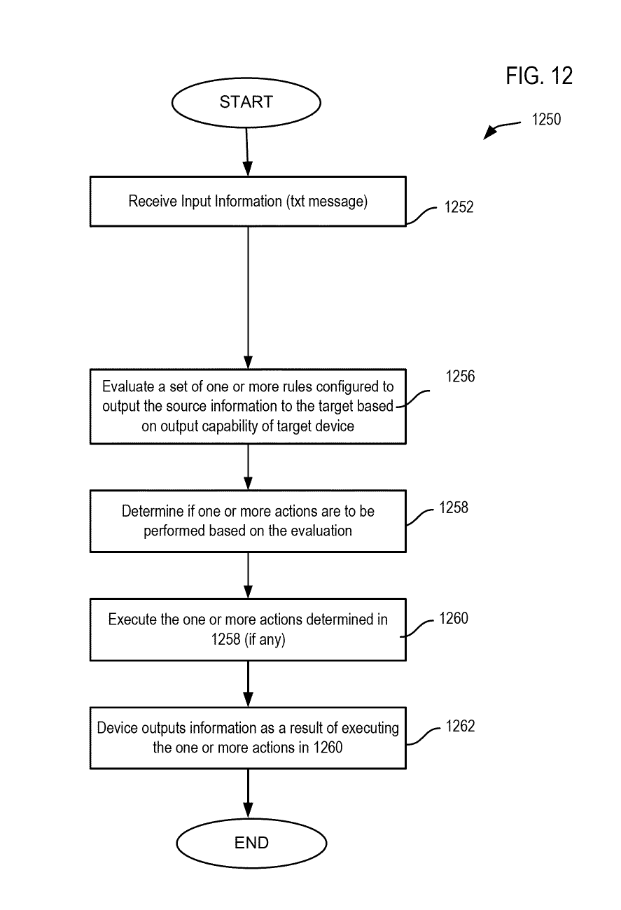

Smart textile input/output device 106, 140 142 may take any of a number of forms and be constructed from smart textiles. In the Example shown in FIG. 13A,B, the device is a flower which wilts and straightens in response to input information.

As discussed herein, a number of messaging events may occur. In one embodiment, a source user may transmit a direct message to a target user by interacting with a smart fabric device. One example of this embodiment is a source user interacting with a smart fabric garment which results in a corresponding output on a target smart fabric garment. Another example is a source user interacting with a messaging input device such as a computer or mobile device which is used to send information generating an output on a target smart fabric garment on a target user. In another embodiment, information provided by indirect input may be provided to a target user. For example, a source user's location may be used to indicate to a target user's smart garment or output device that the source user is within a given distance to the target user. In yet another embodiment, information from a third party may be used to generate target information. For example, information from a social network may be used to indicate that the target user had not interacted with one or more friends on the social network in some period of time.

The various components and modules depicted in system 100 of FIG. 1 are merely examples of components that may be included in system 100. In alternate embodiments, system 100 may have less or more components than those shown. The modules and components in system 100 may be implemented in software (e.g., code, program, instructions that are stored on a machine-readable medium and executed by a processor), hardware, or combinations thereof.

In each of the previous examples, a rule-based engine is used to interpret the direct or indirect input and translate the input information to a corresponding output on an output device.

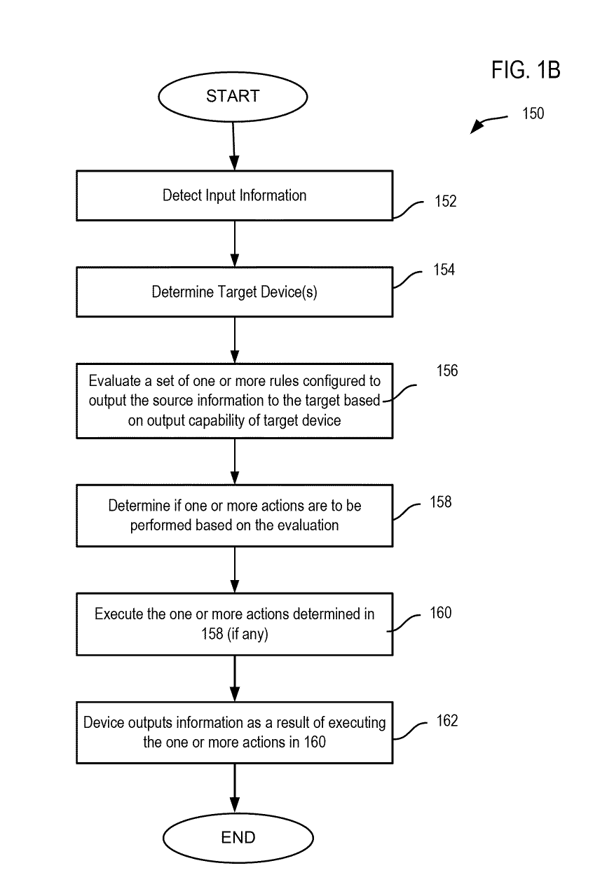

FIG. 1B is a simplified flow chart depicting a process 150 according to an embodiment of the present technology. In one embodiment, the processing depicted in FIG. 1B may be performed by system 200 of FIG. 2.

Referring to FIG. 1b, at step 152, input information detected and/or gathered. The input information may be direct from a source user or indirect from other information sources as described herein. At 154, one or more target devices is determined. In one embodiment, determination of the target device is made by the source device. In another embodiment, message information may be broadcast to a large audience of target devices, and the termination made at the target device 154. A target device may be directly associated with a user or merely accessible to a user. At 156, a set of one or more rules configured for the article of clothing associated with the user is evaluated based on the information detected and/or gathered in step 152 and the target device. Each target device may have different output capabilities, including audio, visual and haptic capabilities. At step 156, the capability and availability of each device is determined. At 158, a determination is made whether one or more actions are to be performed based on the evaluation. In one embodiment, steps 156 and 158 may be performed by rule-based engine 246 of system 200, described below. In general, steps 156 and 158 are preformed at the target device.

At 160, if one or more actions are determined in 158, then the one or more actions are executed. At 162, process 400 may output information as a result of executing the one or more actions in 160. In one embodiment, processing may display the output information on the article of clothing itself or via an external device.

In a first example, direct communication between two articles of clothing is provided. In the following discussion, the first article of clothing 104 is used as an example to explain the workings of system 100. However, it should be noted that other articles of clothing (e.g., the second article of clothing 130 and the nth article of clothing 134) and/or input/output devices (e.g., device 140 and device 142) in system 100 may be configured similarly to implement the present technology, as described below.

An article of clothing in system 100 may be configured to detect and/or gather information associated with a user. For example, the first article of clothing 104 may be configured to detect and/or gather information associated with the first user 102. In one embodiment, the information detected and/or gathered by an article of clothing in system 100 may include unique human and environmental information associated with the user. For example, the unique human and environmental information associated with the user may include information identifying a unique hand shape of the user when the user presses down on the article of clothing, information identifying the amount of pressure associated with the press by the user, information identifying various biometric conditions of the user including body temperature, blood volume pressure, respiration rate, the pulse rate and other physical phenomena of the user, information identifying various motions and activities associated with the user, information identifying the environment associated with the user such as color and photos of the environment, contextual information associated with the user, and the like.

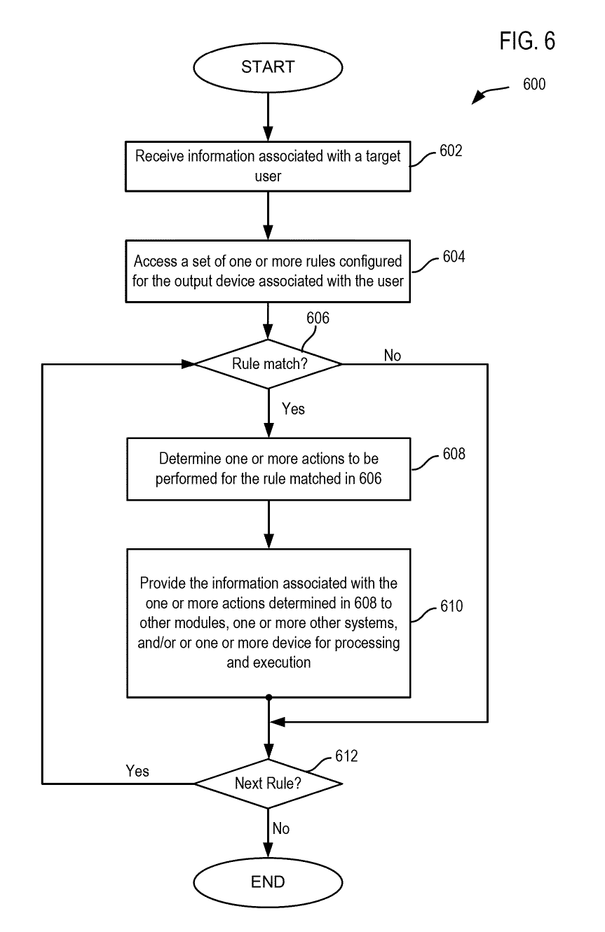

In one embodiment, an article of clothing in system 100 may be configured to detect and/or gather information associated with a user via one or more sensors and other electronic devices embedded in the article of clothing, as will be described in further detail in FIG. 2. For example, the first article of clothing 104 may include one or more sensors which may be used for monitoring various biometric signals originating from the first user 102 indicating body temperature, blood volume pressure, respiration rate, and/or pulse rate of the first user 102. In another example, the first article of clothing 104 may include a detector circuit (which is described in further detail in FIG. 2 and FIG. 7) which is configured to detect a handprint, a drawing, and the like, created by the first user 102 via the first article of clothing 104 (e.g., when the first user 102 presses down on the first article of clothing 104). In the latter example, other information such as the amount of force and duration of the press may also be detected and/or gathered.

In one embodiment, an article of clothing in system 100 may communicate with one or more external devices to gather additional information associated with the user. For example, the first article of clothing 104 may communicate with device 106 which may be a portable computing device, a camera, etc., to gather contextual information associated with the first user 102 such as the user's location, calendar, contacts, color and photo of the user's environment, and the like.

In one embodiment, an article of clothing in system 100 may be configured to provide a rule-based engine to evaluate a set of one or more rules configured for the article of clothing based on the information detected and/or gathered by the article of clothing. A rule configured for an article of clothing identifies a condition and one or more actions to be performed when the condition specified in the rule is met. The set of one or more rules configured for an article of clothing may be user-configurable. The evaluation of one or more rules configured for an article of clothing in system 100 will be discussed in further detail in FIG. 2.

The following examples illustrate several scenarios in which a rule-based engine evaluates a set of one or more rules configured for an article of clothing to determine one or more actions to be performed based on information detected and/or gathered by the article of clothing.

For example, a rule may be configured for the first article of clothing 104 which specifies that “if 2000 steps are detected, then change the color of the article of clothing to RED.” Thus, the condition “if 2000 steps are detected” is evaluated to be true by the rule-based engine when the information detected and/or gathered by the first article of clothing 104 indicates that the first user 102 has walked 2000 steps. As such, the action to “change the color of the article of clothing to RED” is determined to be performed based on the information detected and/or gathered by the first article of clothing 104 and the one or more rules configured for the clothing. This way an article of clothing in system 100 can be “self-triggered” when the condition specified in a rule is met based on the information detected and/or gathered by the article of clothing.

In another example, a rule may be configured for the first article of clothing 104 which specifies that “if the right arm of the first article of clothing 104 is touched, then lighten up the left arm of the second article of clothing 130 and the nth article of clothing 134.” Thus, the condition “if the right arm of the first article of clothing 104 is touched” is evaluated to be true by the rule-based engine when the information detected and/or gathered by the first article of clothing 104 indicates that the right arm of the first article of clothing 104 has been touched. As such, the actions to lighten up the left arms of the second article of clothing 130 and the nth article of clothing 134 are determined to be performed based on the particular information detected and/or gathered by the first article of clothing 104 and the one or more rules configured for the clothing. This way one or more other pieces of clothing in system 100 can react in certain ways according to information detected and/or gathered by an article of clothing and the one or more rules configured for the clothing.

In yet another example, a rule may be configured for the first article of clothing 104 which specifies that “if a unique handprint and an amount of pressure are detected, then display the unique handprint on the second article of clothing 130, and effectuate the equivalent amount of pressure on the second article of clothing 130.” Thus, the condition “if a unique handprint and an amount of pressure are detected” is evaluated to be true by the rule-based engine when the information detected and/or gathered by the first article of clothing 104 indicates that a unique handprint and an amount of pressure are detected. For example, when the first user 102 presses down on the first item of clothing 104, a unique handprint of the user and the amount of pressure used for the press may be detected by the first item of clothing. As such, the actions to display the unique handprint and effectuate the same amount of pressure on the second article of clothing 130 are determined to be performed based on the particular information detected and/or gathered by the first article of clothing 104 and the one or more rules configured for the clothing. This way the second user 132 is “touched” by the first user 102 as a result of the pressure effectuated on the second article of clothing 130, and this is a unique way for the first user 102 to express his love and affection towards the second user 132.

This way system 100 allows personal and human feelings to be communicated between users via one or more articles of clothing associated with each user. As such, system 100 provides a unique advantage over other traditional communication methods e.g., short messaging service (SMS), emails, and so on.

An action determined by a rule-based engine provided by an article of clothing may be executed by the article of clothing itself (also known as the “self-triggering”), by one or more other articles of clothing, and/or by one or more external devices.

If an action determined by a rule-based engine provided by an article of clothing is to be executed by one or more other articles of clothing and/or one or more external devices, then information identifying the action and other information associated with the action are transmitted to these other articles of clothing or devices via network 140 such that the action can be executed by these other articles of clothing or devices. For example, the rule-based engine provided by the first article of clothing 104 evaluates one or more rules configured for the first article of clothing and determines an action to display a unique handprint of the first user 102 on the second article of clothing 130. The information identifying the particular action (display a unique handprint of the first user 102 on the second article of clothing 130) and other information associated with the action (e.g., information identifying the unique handprint of the first user 102) are transmitted to the second article of clothing 130 via network 140. Upon receiving the information, the second article of clothing 130 executes the action, thereby causing the unique handprint of the first user 102 to be displayed on the second item of clothing 130.

In one embodiment, execution of an action determined by a rule-based engine may cause information to be displayed on an article of clothing and/or an external device. For example, an action to display a unique handprint of the first user 102 on the second article of clothing 130 when the first user 102 press down on the first article of clothing 104 is executed to display the unique handprint of the first user 102 on the second article of clothing 130. In other embodiments, execution of an action determined by a rule-based engine may cause an article of clothing to change color or display certain color on the clothing itself.

In one embodiment, execution of an action determined by a rule-based engine may cause an article of clothing to change the surface of clothing via one or more impulses generated in the clothing. For example, an action to effectuate an amount of pressure on the second article of clothing 130 may be executed by the second article of clothing 130 to generate one or more pressure impulses that stimulate the second user 132 via the second article of clothing 130. This way the second user 132 feels “touched” due to the one or more pressure impulses generated in the second item of clothing. Other types of impulses stimulation may include vibration, heat, electrical, and the like. Execution of an action to cause an article of clothing to change shape will be discussed in further detail in FIG. 2.

In this way, system 100 provides a communication system that allows information to be communicated between an article of clothing and other articles of clothing, between an article of clothing and external devices, and/or vice versa.

FIG. 2 is a simplified block diagram illustrating an example system 200. System 200 will be described relative to an article of clothing, but it will be understood that elements of system 200 may be provided in any form of input/output device fabricated from smart textiles according to an embodiment of the present technology. In other input/output devices, not all elements (for example, biometric sensors) may be present. Various combinations of elements shown in FIG. 2 may be used in different input/output devices. For example, system 200 may be implemented in one or more articles of clothing, such as the first article of clothing 104, the second article of clothing 130, and so forth. In the following discussion, the first article of clothing 104 is used as an example to explain the workings of system 200.

The various components depicted in FIG. 2 are merely examples of components that may be included in system 200. In alternate embodiments, system 200 may have less or more components than those shown in FIG. 2. Many of the components as depicted in FIG. 2 can be integrated into the clothing material (as discussed below) or provided in one or more devices coupled to the clothing. The components depicted in FIG. 2 may be implemented in software (e.g., code, program, instructions that are stored in a machine-readable medium and executed by a processor), hardware, or combinations thereof.

As mentioned previously, an article of clothing in system 100 may be configured to detect and/or gather information associated with a user. The information detected and/or gathered by an article of clothing may include unique human and environmental information associated with the user, e.g., information identifying a unique hand shape of the user when the user presses down on the article of clothing, information identifying the amount of pressure associated with the press by the user, information identifying various biometric conditions of the user including body temperature, blood volume pressure, respiration rate, the pulse rate and other physical phenomena of the user, information identifying various motions and activities associated with the user, information identifying the environment associated with the user such as color and photos of the environment, contextual information associated with the user, and the like.

As depicted in FIG. 2, system 200 may include various components to enable a smart textile input output include an information gathering module 220 that is configured to detect and/or gather information associated with a user. For example, information gathering module 220 of system 200 may be implemented in the first article of clothing 104 to detect and/or gather information associated with the first user 102.

In one embodiment, information gathering module 220 may include one or more biometric sensors 205 that are configured to monitor one or more biometric signals originating from the user and gather information identifying various physical phenomena of the user, e.g., body temperature, blood volume pressure, respiration rate, pulse rate, and so on.

In one embodiment, information gathering module 220 may include a detector 206 that is configured to detect and/or gather information identifying one or more static shapes (e.g., a handprint) and/or drawings created by the user via the article of clothing. For example, when the first user 102 of the first article of clothing 104 presses down on the first article of clothing 104, a static shape such as a unique hand shape of the first user 102 is detected and information identifying the unique hand shape of the user may be gathered by detector 206. In another example, the first user 102 may press down on the first article of clothing 104 more than once over a period time such that each of these presses is tracked over time to identify a drawing or writing. In one embodiment, detector 206 in information gathering module 220 may further be configured to detect and/or gather information identifying an amount of force associated with a press.

Detector 206 may implement various devices and technologies to detect and/or gather information identifying shapes, drawings, and/or other information (e.g., amount of force and duration of a press) associated with the user of the article of clothing.

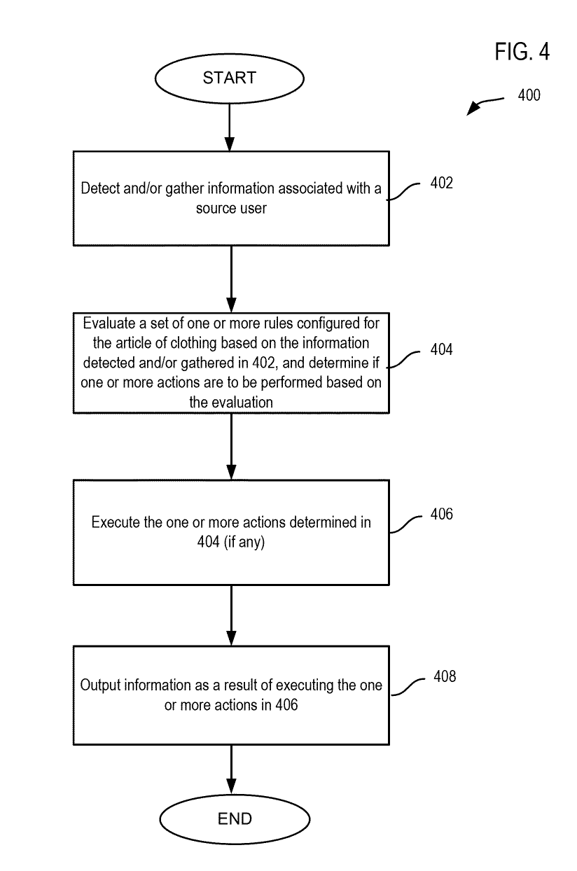

In one embodiment, detector 206 may implement a matrix of resistors and other electronics (e.g., one or more operational amplifiers, a processor, etc.) embedded in the article of clothing to detect static shapes, drawings, and other information associated with the user of the article of clothing. Each resistor of the matrix of resistors may correspond to a “button”. When the user presses down on the article of clothing, one or more “buttons” are pressed. By monitoring the current in the embedded circuit and measuring the amount of resistance and/or current change in the embedded circuit in response to the press by the user, the one or more “buttons” that were pressed and the amount of force used for each “button” pressed can be determined. Based on the one or more “buttons” pressed and the amount of force used for each “button” pressed, detector 206 can identify a static shape or a drawing (by tracking multiple presses over time). For example, detector 206 can distinguish a round shape from a square shape by determining the one or more “buttons” that were pressed and the amount of force used for each “button” pressed. An example configuration of a matrix of resistors for implementing detector 206 will be discussed in further detail in FIG. 5.

In one embodiment, detector 206 may implement one or more piezoelectric sensors that use the piezoelectric effect to measure pressure, acceleration, strain, or force. Piezoelectric is well-known in the art and thus will not be described further here.

In one embodiment, information gathering module 220 may include one or more light sensors 207 that are configured to detect and/or gather information associated with the user. The one or more light sensors may be implemented as a matrix of light sensors weaved into the fabric of the article of clothing to detect shadows of an object or an action performed by the user. For example, the one or more light sensors 207 may detect a hand gesture initiated by the user, e.g., a caress.

In one embodiment, information gathering module 220 may include one or more other devices 208 for detecting and/or gathering additional information associated with the user. For example, information gathering module 220 may include a camera for capturing one or more photos of the environment, a voice recognition device for detecting voice and speech input from the user, a timer, a positioning device, just to name a few. In this way, various kinds of information associated with a user may be detected and/or gathered by information gathering module 220 of system 200.

As discussed previously, an article of clothing in system 100 may be configured to provide a rule-based engine to evaluate a set of one or more rules configured for the article of clothing based on the information detected and/or gathered by the article of clothing, and determine one or more actions to be performed when one or more rules are met.

As depicted in FIG. 2, an information processing module 240 may be provided in system 200 and includes a rule-based engine 242 that is configured to evaluate one or more rules configured for the particular article of clothing and determine one or more actions to be performed based on the information detected and/or gathered by information gathering module 220. Each of the set of one or more rules configured for the article of clothing identifies a condition and one or more actions to be performed when the condition specified in the rule is met. In one embodiment, the set of rules configured for the particular article of clothing may be stored in a data repository 246. Data repository 246 may be implemented in information processing module 240. Alternatively, data repository 246 may be implemented in a remote data server accessible to rule-based engine 242 via network 140 of FIG. 1. The set of rules may be configured dynamically to suit the needs of different users. For example, the rules may be configurable via a user interface (not shown). Rules may be provided by the output device manufacturer and/or configurable by the user of the output device.

In one embodiment, rule-based engine 242 is configured to evaluate a set of one or more rules stored in data repository 246 based upon the information detected and/or gathered by information gathering module 220. For example, a rule configured for the first article of clothing 104 and stored in data repository 246 may specify that “IF (Number_Steps==2000) THEN {Color(article_104)=RED}.” Thus, the condition “IF (Number_Steps==2000)” would be evaluated to be true and satisfied by rule-based engine 242 if the information detected and/or gathered by information gathering module 220 indicates that the first user 102 has completed 2000 walking steps. As such, an action to change the color of the first article of clothing 104 to RED is determined to be performed.

In another example, a rule configured for the first article of clothing 104 and stored in data repository 246 may specify that “IF (Right_Arm (104)) THEN {Left Arm (article_130, article_134)=BLUE}.” Thus, the condition “IF (Right_Arm (104))” will be evaluated to be true and satisfied by rule-based engine 242 if the information detected and/or gathered by information gathering module 220 indicates that the right arm of the first article of clothing 104 has been touched or pressed. As such, an action to change the color of the articles of clothing 130 and 134 to BLUE is determined to be performed.

In this way, many different rules configured for an article of clothing may be evaluated by rule-based engine 242 to determine one or more actions to be performed based on the information detected and/or gathered by information gathering module 220.

As mentioned previously, an action determined by a rule-based engine provided by an article of clothing may be executed by the article of clothing itself (also known as the “self-triggering”), by one or more other articles of clothing, and/or by one or more external devices. If an action determined by a rule-based engine provided by an article of clothing is to be executed by one or more other articles of clothing and/or one or more external devices, then information identifying the action and other information associated with the action are transmitted to these other articles of clothing or devices via network 140 such that the action can be executed by these other articles of clothing or devices.

As depicted in FIG. 2, system 200 implemented in an article of clothing may include an output module 260 that is configured to execute one or more actions determined by information processing module 240. Output module 260 may implement various devices and technologies for executing one or more actions determined by information processing module 240 as discussed below.

In one embodiment, output module 260 may implement one or more Light-Emitting Diodes (LEDs) and/or Light Crystal Displays (LCDs) 262 to display information on an article of clothing. For example, an action to display a unique handprint on the second article of clothing 104 may be executed by output module 260 of the second article of clothing 130 to display the unique handprint on the second article of clothing 130 via one or more LEDs and/or LCDs 262 implemented in output module 260.

In one embodiment, output module 260 may implement color changing inks 264 such as photochromics, thermochromics, electrochromics, to cause an article of clothing to change color in response to light, heat, or electrical charges. In one embodiment, these color changing inks 264 may be screen printed on the fabric or woven into one or more threads of the clothing. For example, an action to change the color of both arms of the second article of clothing 130 to the color of red may be executed by output module 260 of the second article of clothing 130 to display the red color on both arms of the second article of clothing 130.

In one embodiment, output module 260 may implement haptics and/or shape memory materials 266 to cause an article of clothing to change shape, size, or move. Haptics refers to a tactile feedback technology that uses a user's sense of touch by applying forces, vibrations, and the like, to the user. Shape memory materials (e.g., electro-active polymers and related technologies, shape memory alloy, etc.) can transform thermal energy into motion and may be used as an actuator to make things move, release substance, and many more. Shape memory materials may exist in the form of threads which can be woven into the fabric of an article of clothing.

For example, an action to effectuate an amount of pressure on the second article of clothing 130 may be executed by output module 260 of the second article of clothing 130 to generate one or more pressure impulses that stimulate the second user 132 with feelings and sensations via the second article of clothing 130. This way the second user 132 feels “touched” via the second item of clothing. Other types of impulses stimulation may include vibration, heat, electrical, and the like.

System 200 implemented in an article of clothing or other smart fabric input/output device may further include a communication module 270 that is configured to enable communications between the individual elements within system 200, between an article of clothing and a user of the article of clothing, between an article of clothing and one or more other articles of clothing, and/or between an article of clothing and an external device. The communication module may include one or more wired and wireless networking components enabling the communication module to send and receive data. By way of example, the communication module 270 may include a wireless radio addressable by a network address and/or cellular address.

In this way, system 200 may implemented in an article of clothing or other output device to allow various information associated with a user to be gathered and evaluated to determine one or more actions to be performed. The executions of these one or more actions cause various kinds of information to be communicated between an article of clothing and one or more other articles of clothing, between an article of clothing and one or more external devices, and/or vice versa.

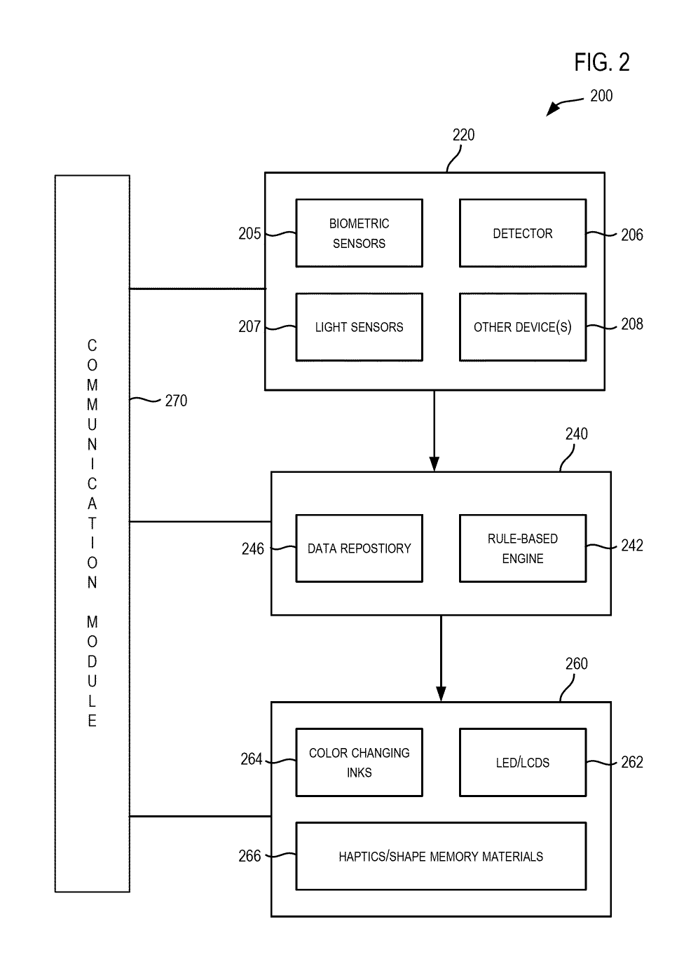

FIG. 3 is an example of a computing device for implementing the present technology. In one embodiment, the computing device of FIG. 3 provides more detail for the one or more articles of clothing and/or the one or more external devices depicted in FIG. 1. The computing device of FIG. 3 is only one example of a suitable computing environment and is not intended to suggest any limitation as to the scope of use or functionality of the present technology. Neither should the computing environment be interpreted as having any dependent requirement relating to any one or combination of components illustrated in the exemplary operating environment.

The present technology is operational in numerous other general purpose or special computing system environments or configurations. Examples of well known computing systems, environments, and/or configurations that may be suitable for implementing the present technology include, but are not limited to personal computers, server computers, laptop devices, multiprocessor systems, microprocessor-based systems, network PCs, minicomputers, mainframe computers, distributed computing environments that include any of the above systems or the like.

The present technology may be described in the general context of computer-executable instructions, such as program modules, being executed by a computer. Generally, program modules include routines, programs, objects, components, data structures, etc., that perform a particular task or implement particular abstract data types. The present technology may be also practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the technology herein includes a general purpose computing device in the form of a computer 310. Components of computer 310 may include, but are not limited to, a processing unit 320, a system memory 330, and a system bus 321 that couples various system components including system memory 330 to processing unit 320. System bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

Computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 341 is typically connected to system bus 321 through a non-removable memory interface such as interface 340, and magnetic disk drive 351 and optical disk drive 355 are typically connected to system bus 321 by a removable memory interface, such as interface 350.

The drives and their associated computer storage media discussed above and illustrated in FIG. 3, provide storage of computer readable instructions, data structures, program modules and other data for computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into computer 30 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to system bus 321 via an interface, such as a video interface 390. In addition to the monitor, computers may also include other peripheral output devices such as speakers 397 and printer 396, which may be connected through an output peripheral interface 390.

Computer 310 may operate in a networked environment using logical connections to one or more remote computers, such as a remote computer 380. Remote computer 380 may be a personal computer, a server, a router, a network PC, a peer device or other common network node, and typically includes many or all of the elements described above relative to computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, computer 310 is connected to LAN 371 through a network interface or adapter 370. When used in a WAN networking environment, computer 310 typically includes a modem 372 or other means for establishing communications over WAN 373, such as the Internet. Modem 372, which may be internal or external, may be connected to system bus 321 via user input interface 360, or other appropriate mechanism. In a networked environment, program modules depicted relative to computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

Those skilled in the art will understand that program modules such as operating system 334, application programs 345, and data 337 are provided to computer 310 via one of its memory storage devices, which may include ROM 331, RAM 332, hard disk drive 341, magnetic disk drive 351, or optical disk drive 355. Hard disk drive 341 is used to store data 337 and the programs, including operating system 334 and application programs 345.

When computer 310 is turned on or reset, BIOS 333, which is stored in ROM 331 instructs processing unit 320 to load operating system 334 from hard disk drive 341 into RAM 332. Once operating system 334 is loaded into RAM 332, processing unit 320 executes the operating system code and causes the visual elements associated with the user interface of the operating system to be displayed on the monitor. When a user opens an application program 345, the program code and relevant data are read from hard disk drive 341 and stored in RAM 332.

Aspects of the present technology may be embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. In accordance with an illustrative embodiment of the Internet, a plurality of local LANs and a WAN can be interconnected by routers. The routers are special purpose computers used to interface one LAN or WAN to another.

Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs or the WAN via a digital communications device, modem and temporary telephone, or a wireless link. The Internet has recently seen explosive growth by virtue of its ability to link computers located throughout the world. As the Internet has grown, so has the WWW.

As is appreciated by those skilled in the art, the WWW is a vast collection of interconnected or “hypertext” documents written in Hyper-Text Markup Language (“HTML”), or other markup languages, that are electronically stored at or dynamically generated by “WWW sites” or “Web sites” throughout the Internet. Additionally, software programs that are implemented in merchant system 110 of FIG. 1 and communicate over the Web using the TCP/IP protocol, are part of the WWW, such as JAVAS applets, instant messaging, e-mail, browser plug-ins, Macromedia Flash, chat and others. Other interactive hypertext environments may include proprietary environments such as those provided by an number of online service providers, as well as the “wireless Web” provided by various wireless networking providers, especially those in the cellular phone industry. It will be appreciated that the present technology may apply in any such interactive communication environments. For purposes of discussion, the Web is used as an exemplary interactive hypertext environment with regard to the present technology.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVAS programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Microsoft's Internet Explorer, is a software application program for providing a user interface to the WWW. Using the web browser via a remote request, the web browser requests the desired hypertext document from the appropriate web server using the URL for the document and the HyperTextTransport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

As discussed above, various kinds of information associated with a user may be detected and/or gathered. Further, one or more rules configured for an item of clothing may be evaluated to determine one or more action to be performed based on the information that is detected and/or gathered. Executions of the one or more actions may cause various kinds of information to be communicated between an article of clothing and one or more other articles of clothing, between an article of clothing and one or more external devices, and/or vice versa.

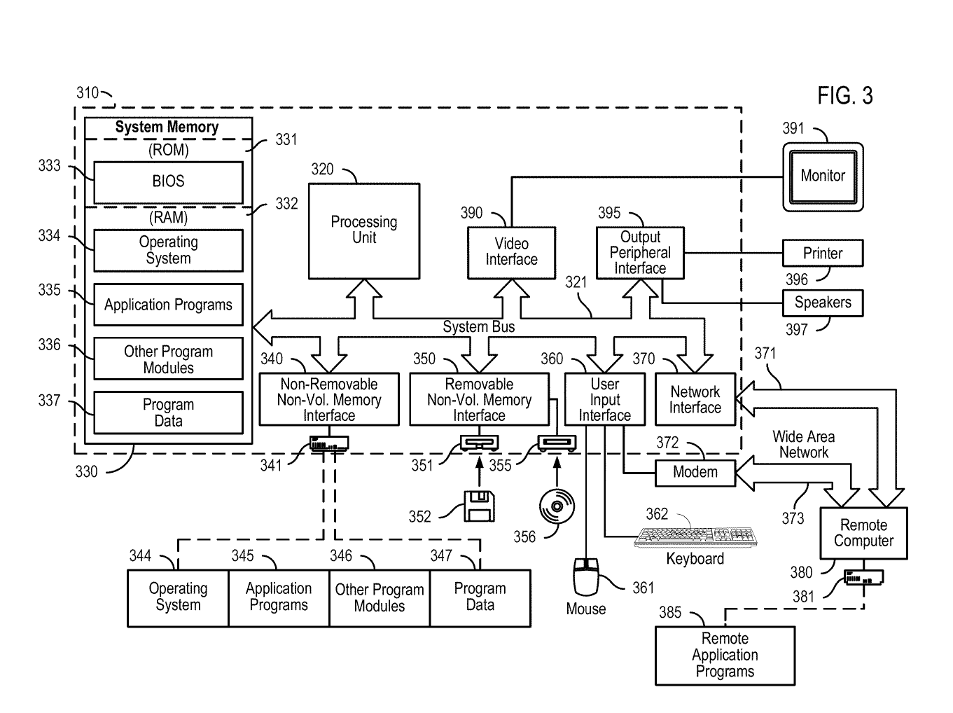

FIG. 4 is a simplified flow chart depicting a process 400 according to an embodiment of the present technology. In one embodiment, the processing depicted in FIG. 4 may be performed by system 200 of FIG. 2. As mentioned previously, system 200 may be implemented in one or more articles of clothing and/or other output devices as depicted in FIG. 1.

Referring to FIG. 4, at step 402, information associated with a user is detected and/or gathered. Where the source user wishes to transmit information using a target device such as a mobile phone, the target user may enter the information into a dedicated application running on the mobile device which outputs the information to the target user. Alternatively, the source user may compose an SMS message directed to an address associated with the target device which is transformed by the target device into information which may be displayed by the target device. In an embodiment where the source user is using a clothing input device, the information associated with a user may be detected and/or gathered by information gathering module 220 of system 200 implemented in an article of clothing associated with the user. For example, information gathering module 220 of system 200 may include one or more biometric sensors 205 to monitor one or more biometric signals originating from the user and gather information identifying various physical phenomena of the user, detector 206 to detect and/or gather information identifying one or more static shapes (e.g., a handprint) and/or drawings created by the user via the particular article of clothing, one or more light sensors 207 to detect and/or gatherer information identifying an action performed by the user (e.g., a hand gesture), and/or one or more other devices 208 for detecting and/or gathering additional information associated with the user, such as color and photos of the environment, and the like. Processing for detecting and/or gathering information associated with a user is discussed in more detail below with respect to the process of FIG. 5.

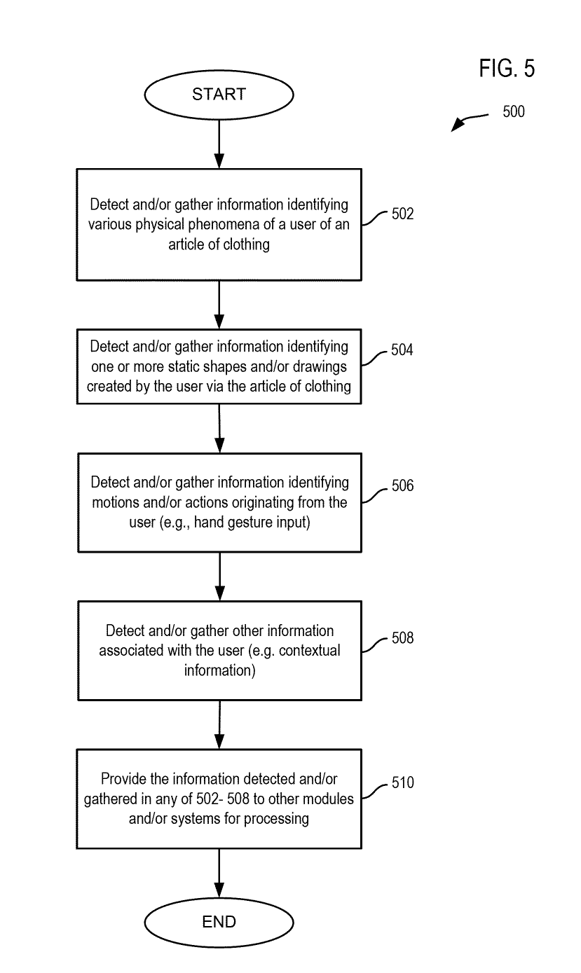

At 404, a set of one or more rules configured for the article of clothing associated with the user is evaluated based on the information detected and/or gathered in step 402, and determines if one or more actions are determined to be performed based on the evaluation. In one embodiment, step 404 may be performed by rule-based engine 246 of system 200 to evaluate a set of one or more rules stored in data repository 246 based upon the information detected and/or gathered in step 402. For example, a rule that is configured for the first article of clothing 104 and stored in data repository 246 may specify that “IF (Number_Steps==2000) THEN {Color(104)=RED}.” Thus, if the information detected and/or gathered in step 402 indicates that the first user 102 has completed 2000 walking steps, then the condition “IF (Number_Steps==2000)” is evaluated to be true in step 404. As such, an action to change the color of the first article of clothing 104 to RED is determined to be performed according to step 404. Processing for evaluating a set of one or more rules to determine one or more actions to be performed is discussed in more detail below with respect to the process of FIG. 6.

At 406, if one or more actions are determined in 404, then the one or more actions are executed. In one embodiment, step 406 may be performed by output module 260 of system 200 implemented in the article of clothing itself (also known as the “self-triggering”), by output module 260 of system 200 implemented in one or more other articles of clothing, and/or by one or more external devices.

If an action determined in 404 is to be executed by one or more other articles of clothing and/or one or more external devices, then information identifying the action and other information associated with the action are transmitted to these other articles of clothing or devices via network 140. Upon receiving the information identifying the action and other information associated with the action, these other articles of clothing and/or external devices may then execute the action based on the information received.

At 408, process 400 may output information as a result of executing the one or more actions in 406. In one embodiment, processing may display the output information on the article of clothing itself or via an external device. For example, an action to display a unique handprint of the first user 102 on the second article of clothing 130 may be executed by the output module of system 200 implemented in the second article of clothing 130 to display the unique handprint of the first user 102 on the second item of clothing 130. Execution of the one or more actions in step 406 may also cause other information to be displayed, e.g., a drawing, colors and/or photos of certain environment, and the like. As such, unique and personal information associated with a user of an article of clothing may be transmitted to one or more other user of other articles of clothing via the article of clothing associated with each user.

In one embodiment, execution of the one or more actions in step 406 may change the surface of the article of clothing in response to one or more impulses (e.g., pressure, vibration, heat, electric impulses, etc.) generated as a result of executing the actions.

As discussed previously, various kinds of information associated with a user may be detected and/or gathered. The information detected and/or gathered may include unique human and environmental information associated with the user, e.g., information identifying a unique hand shape of the user, information identifying a drawing created by the user, information identifying the environment associated with the user such as color and photos of the environment, and the like.

FIG. 5 is a simplified flow chart depicting a process 500 for detecting and/or gathering information associated with a user according to an embodiment of the present technology. The processing depicted in FIG. 5 may be performed by information gathering module 220 of system 200 as depicted in FIG. 2. The processing depicted in FIG. 5 provides more details for step 402 of FIG. 4.

It should be noted that steps 502 to 508 illustrated in FIG. 5 may be performed in parallel or simultaneously, and each of these steps 502 and 508 may be performed continuously to detect and/or gather information associated with the user.

Referring to FIG. 5, at 502, one or more biometric signals originating from the user may be detected and information about the user, e.g., information identifying the body temperature, blood volume pressure, respiration rate, the pulse rate, and/or other physical phenomena of the user, may be gathered. In one embodiment, one or more biometric sensors (e.g., biometric sensors 205 of FIG. 2) implemented in information gathering module 220 of system 200 may be configured to detect one or more biometric signals originating from the user and gather information identifying the physical phenomena of the user.

At 504, information identifying one or more static shapes (e.g., a handprint) and/or drawings may be detected and/or gathered. In one embodiment, detector 206 implemented in information gathering module 220 of system 200 may be configured to detect and/or gather information identifying one or more static shapes and/or drawings created by the user via an article of clothing associated with the user. For example, information identifying a unique hand shape of the first user 102 may be detected and/or gathered in step 504 when the first user 102 presses down on the first article of clothing 130 associated with the first user. In another example, information identifying a drawing or writing (e.g., a “heart” shape) may be detected and/or gathered in step 504 when the first user 102 initiates multiple random presses on the first article of clothing 104 over a period time such that a history of these random presses is tracked over time to generate the drawing or writing.

At 506, information identifying motions and/or actions originating from the user may be detected and/or gathered. For example, information identifying a hand gesture initiated by the user, e.g., a caress, may be detected and/or gathered in step 506. In one embodiment, one or more light sensors 207 implemented in information gathering module 220 of system 200 may be configured to detect and/or gather information identifying the motions and/or actions originating from the user. The one or more light sensors may be weaved into the fabric of the article of clothing.

At 508, other information associated with the user may be detected and/or gathered. For example, contextual information identifying colors and/or photos of the environment associated with the user may be detected and/or gathered in step 508. Other information associated with the user that may be detected and/or gathered in step 508 may include location information associated with the user, calendar and contacts of the user, and the like. In one embodiment, one or more other devices may be implemented in information gathering module 220 of system 200 to perform step 508, e.g., a camera, a timer, a positioning device, just to name a few. Alternatively, information associated with the user may be gathered from one or more external devices associated with the user. For example, information identifying the user's location, calendar, contacts, and the like may be gathered from device 106 of FIG. 1, which may be a portable computing device used by the user.

At 510, the information detected and/or gathered by any of the steps 502 to 508 may be provided to other modules for further processing. In one embodiment, the information detected and/or gathered by any of the steps 502 to 508 may be provided to information processing module 240 of system 200 for processing as discussed below in FIG. 6.

This way various kinds of information associated with the user may be detected and/or gathered by performing the processing as described above.

As discussed previously, a set of one or more rules may be evaluated by a rule-based engine to determine one or more actions to be performed based on information detected and/or gathered by inform gathering module 220 of system 200 implemented in an article of clothing.

FIG. 6 is a simplified flow chart depicting a process 600 for evaluating a set of one or more rules to determine one or more actions to be performed according to an embodiment of the present technology. The processing depicted in FIG. 6 may be performed by information processing module 240 of system 200 as depicted in FIG. 2. The processing depicted in FIG. 6 provides more details for step 404 of FIG. 4.

Referring to FIG. 6, at 602, information associated with a target user is received. In one embodiment, the information associated with the target user is received by information processing module 240 of system 200 implemented in an article of clothing associated with the user. The information received in step 602 may include unique human and environmental information associated with the user, e.g., information identifying a unique hand shape of the user, information identifying a drawing created by the user, information identifying the environment associated with the user such as color and photos of the environment, and the like.

At 604, process 600 may access a set of one or more rules configured for the article of clothing associated with the user. In one embodiment, process 600 may access data repository 246 of system 200 to access a set of one or more rules configured for the article of clothing associated with the user. For example, a set of rules may be configured for the first article of clothing 104 associated with the first user 102 and stored in data repository 246. Alternatively, process 600 may access a remote data server that stores a set of one or more rules configured for an article of clothing associated with the user. Each of the set of one or more rules configured for an article of clothing identifies a condition and one or more actions to be performed when the condition specified in the rule is met. The set of rules may be configured dynamically to suit the needs of different users.

At 606, a rule in the set of one or more rules accessed in step 604 is evaluated based upon the information received in 602. In one embodiment, a rule in the set of one or more rules is evaluated by rule-based engine 242 of system 200 based upon the information received in 602. For example, a rule configured for the first article of clothing 104 may specify “IF (Number_Steps==2000) THEN {Color (article_104)=RED}.” Thus, the condition “IF (Number_Steps==2000)” is evaluated to be true by rule-based engine 242 if the information detected and/or gathered by information gathering module 220 indicates that the first user 102 has completed 2000 walking steps.

At step 608, if a rule in the set of one or more rules is evaluated to be true and satisfied in step 606, process 600 determines that the one or more actions specified in the rule are to be performed. In the above example, an action to change the color of the first article of clothing 104 to RED is determined to be performed as a result of the rule evaluation performed in step 606.

At step 610, information identifying the one or more actions determined in step 608 and other information associated with the one or more actions may be provided to one or more other modules and/or one or more other systems for processing. In one embodiment, information identifying the one or more actions determined in step 608 may be provided to output module 260 of system 200 implemented in an article of clothing to be executed by output module 260. For example, information identifying an action to display a unique handprint of the first user 102 on the second article of clothing 130 and other information associated with the action (e.g., information identifying the unique handprint of the first user 102) are transmitted to the second article of clothing 130 via network 140. Upon receiving the information, output module 260 of system 200 implemented in second article of clothing 130 executes the action, thereby causing the unique handprint of the first user 102 to be displayed on the second item of clothing 130.

At 612, process 600 determines if there are one or more other rules in the set of one or more rules to be evaluated. If there are one or more other rules to be evaluated, then process 600 returns to step 606. Otherwise, process 600 terminates.

As discussed previously, detector 206 of information gathering module 220 in system 200 may implement a matrix input elements, which in one embodiment may comprise resistors and other electronics (e.g., one or more operational amplifiers, a processor, etc.), embedded in an article of clothing to detect static shapes, drawings, and other information associated with the user of the article of clothing. Each resistor of the matrix of resistors may correspond to a “button”. When the user presses down on the article of clothing, one or more input elements or “buttons” are pressed. By monitoring the current in the circuit and measuring the amount of resistance and/or current change in the embedded circuit in response to the press by the user, the one or more “buttons” that were pressed and the amount of force used for each “button” pressed can be determined. Based on the one or more “buttons” pressed and the amount of force used for each “button” pressed, detector 206 may identify a static shape or a drawing (by tracking the history of multiple presses over time) created by the user via the article of clothing.

FIG. 7 is a simplified schematic diagram of an example circuit 700 according to an embodiment of the present technology. Circuit 700 depicted in FIG. 7 may be implemented in detector 206 of information gathering module 220. The various components and modules depicted in circuit 700 are merely examples of components that may be included in the circuit. In alternate embodiments, circuit 700 may have less or more components than those shown.

Referring to FIG. 7, circuit 700 may include a matrix of input elements comprising resistors 720. In one embodiment, matrix 720 may include a plurality of variable resistors with each resistor connecting a unique row and column pair. For example, matrix 720 may include resistor R11 connecting row 1 and column 1, resistor R12 connecting row 1 and column 2, resistor R13 connecting row 1 and column 3, resistor R21 connecting row 2 and column 1, R22 connecting row 2 and column 2, R23 connecting row 2 and column 3, R31 connecting row 3 and column 1, R32 connecting row 3 and column 2, and R33 connecting row 3 and column 3 Although matrix 720 as illustrated in FIG. 7 is a 3×3 matrix, other matrix size may be used with more or less resistors than those illustrated in FIG. 7.

In one embodiment, each resistor in the matrix of resistors may be coupled to a switch. For example, as depicted in FIG. 7, resistor R11 is coupled to switch S11, resistor R12 is coupled to switch S12, resistor R13 is coupled to switch S13, resistor R21 is coupled to switch S21, resistor R22 is coupled to switch S22, resistor R31 is coupled to switch S31, resistor R32 is coupled to switch S32, and resistor R33 is coupled to switch S33. As discussed previously, each resistor of the matrix of resistors may correspond to a “button.” When the user presses down on the article of clothing, one or more “buttons” are pressed. When a “button” is pressed, the switch that is coupled to the particular resistor (i.e., the resistor that corresponds to the “button” pressed) is closed, thereby creating a short circuit. On the other hand, if a “button” is not pressed, the switch that is coupled to the particular resistor (i.e., the resistor that corresponds to the button pressed) remains open, thereby creating an open circuit.

As depicted in FIG. 7, circuit 700 may also include a plurality of operational amplifiers (“op-amp”) with each op-amp connected to one of the plurality of rows. For example, row 1 is connected to the summing node of op-amp 702, row 2 is connected to the summing node of op-amp 704, row 3 is connected to the summing node of op-amp 705, and so on. The other input terminal of each of the op-amps may be connected to the ground voltage. In one embodiment, each of the operation amplifiers is implemented as a transimpedance amplifier (current-to-voltage converter) that takes an electric current as an input signal and produces a corresponding voltage as an output signal. The output voltage is proportional to the input current.

Circuit 700 may further include other electronics, e.g., processor (not shown), a monitoring circuit, etc. By way of example only, circuit 700 may include multiplexor 708 and an analog-to-digital convertor (ADC) 709 for reading and converting the output voltage of each of the operation amplifiers to a digital value. The basic operation for circuit 700 is described below.

Initially, a first column for the matrix of resistors is driven to a first voltage, while the remaining columns and all of the rows are driven to a second voltage. For example, column 1 may be driven to the first voltage (e.g., Vdd), while column 2, column 3, row 1, row 2, and row 3 may be driven to the second voltage (e.g., ground). As such, no current flows across those resistors that have the same voltage level on both ends. In this example, no current flows across resistors R12, R13, R22, R23, R32, and R33 since both terminals of these resistors are at the same voltage level (i.e., the second voltage).

However, for the one particular column (e.g., column 1) that was driven to the first voltage, current will flow from the particular column, through the respective resistors, into the respective rows, provided that the switch coupled to the respective resistor is closed. For example, when the “button” that corresponds to resistor R11 is pressed, switch S11 is closed, thereby causing current to flow from column 1, through resistor R11, into row 1 (the input current to the summing node of op-amp 702). In this way, by detecting if there is any current flowing into a row, it can be determined which particular “button” has been pressed. In this example, since current flows into row 1, the “button” that corresponds to resistor R11 is identified as the “button” being pressed. On the other hand, since no current flows into row 2 and row 3, the “button” that corresponds to the respective resistors R21 and R31 is not pressed.

In addition, the amount of force used when a particular ‘button” is pressed can also be determined by measuring the amount of resistance and/or current change in response to the “button” pressed. As discussed above, each resistor in matrix 720 may be configured as a variable resistor. In one embodiment, the resistance value for each variable resistor may be configured based upon the amount of pressure or force used when the corresponding button is pressed. For example, resistor R11 may be configured to have a resistance value of 1MΩ in the unpressed state, a resistance value of 100Ω when the button is half-pressed, a resistance value of 5Ω when the button is fully pressed. In another example, resistor R11 may be configured to have a resistance value of 100Ω when zero unit of force is used (i.e., unpressed state), a resistance value of 50Ω when 20 units of force is used, a resistance value of 15Ω when 5 units of force is used. There are many different ways to configure a variable resistor such that the amount of force used when the particular button is press is correlated to the variable resistance value associated with the variable resistor.

Thus, by measuring the amount of resistance change and/or the amount of current change (the amount of current change is inversely proportional to the amount of resistance change) when a corresponding button is pressed, the amount of force used for the button pressed can be determined.

After the first column of matrix 720 has been checked for any button pressed as described above, a next column is then read and checked as described above. For example, column 2 may be driven to the first voltage (e.g., Vdd), while column 1, column 3, row 1, row 2, and row 3 may be driven to the second voltage (e.g., ground). This process continues until all of the columns of matrix 720 have been checked for any button pressed.

In one embodiment, circuit 700 may perform a periodic check of all of the columns in matrix 720 to determine if any key is pressed, e.g., every 10 ms. If it is detected that any current flows into a row, a detailed check may then be performed to identify which particular button has been pressed. After checking for all of the columns in matrix 720, circuit 700 may return to a low-power sleep mode until another check is invoked. This way the amount of power consumed by circuit 700 is reduced or minimized.

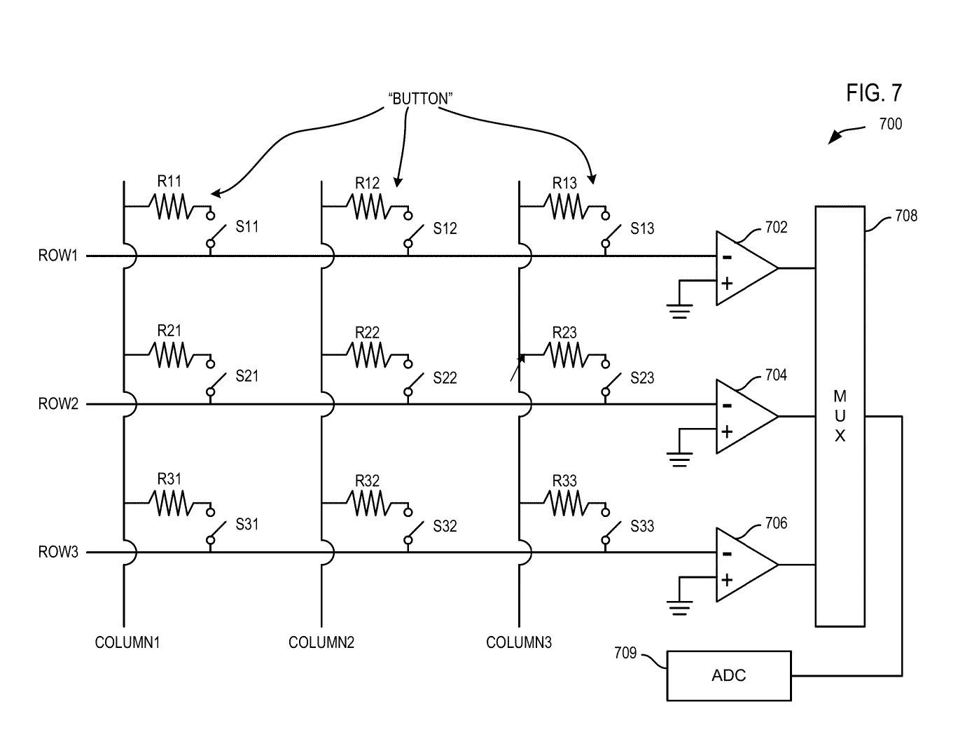

FIG. 8 is a simplified flow chart depicting a process 800 according to an embodiment of the present technology. The processing depicted in FIG. 8 may be performed by circuit 700 as depicted in FIG. 7.

Referring to FIG. 8, at 802, process 800 may access a matrix of resistors such as the matrix of resistors 720 as illustrated in FIG. 7. For example, circuit 700 of FIG. 7 illustrates a 3×3 matrix of resistors with each resistor connecting a unique row and column pair. As depicted in FIG. 7, each resistor in matrix 720 is also coupled to a switch, which may present an open in an unpressed state.

At 803, one of the columns of the matrix of resistors accessed in step 802 is selected for applying a unique voltage that is different than the voltages applied to other columns and rows (See step 804). The particular column may be selected according to a sequential order, e.g., the first column, the second column, the third column, and so on. The basic idea is to check each column for any button pressed until all the columns have been read and checked according to the processing described below.

At 804, a first voltage is applied to the column selected in step 803, while a second voltage is applied to the remaining columns and all the rows of the matrix of resistors accessed in step 802. For example, a first voltage of Vdd may be applied to column 1 of the matrix of resistors (column 1 is the column selected in 803), while a second voltage of ground may be applied to all of the remaining columns and all the rows of the matrix of resistors accessed in step 802.

At 806, process 800 detects if any current flows into one or more rows of the matrix of resistors accessed in step 802. As discussed previously, no current flows across those resistors that have the same voltage level on both ends. Thus, no current flows across the resistors that have the second voltage applied to both terminals. However, for the selected column that was driven to the first voltage, current is detected to flow from the selected column, through the respective resistors, into the respective rows, if the switch coupled to the respective resistor is closed in the pressed state. For example, referring to FIG. 7 (assume that column 1 is the selected column which is driven to the first voltage), when a “button” that corresponds to resistor R11 is pressed, switch S11 is closed, thereby causing current to flow from column 1, through resistor R11, into row 1 (this is the input current to the summing node of op-amp 702). Thus, process 800 detects current flowing into row 1, but does not detect any current flowing into row 2 and row 3.

If process 800 does not detect any current flowing into one or more rows in the matrix of resistors, process 800 proceeds to step 814 to scan the next column until all columns in the matrix of resistors accessed in step 802 have been read and checked for any button pressed.

If process 800 detects any current flowing into one or more rows in the matrix of resistors, the one or more buttons pressed are identified at step 810. Continuing with the above example, since column 1 is currently driven to the first voltage while all other columns and rows are driven to the second voltage, and further it is detected that current flows into row 1, the button that corresponds to resistor R11 is identified as the button being pressed.

At 812, the amount of force that was used to press each of one or more buttons identified in step 810 is determined. In one embodiment, the amount of force for each “button” pressed is determined by measuring the amount of resistance and/or current change in response to each “button” pressed. As discussed above, each resistor in the matrix of resistors accessed in step 802 may be a variable resistor. The resistance value for each variable resistor can be varied depending upon the amount of pressure or force used when the corresponding button is pressed. For example, a resistor may be configured to have a resistance value of 100Ω when zero unit of force is used for the press (i.e., unpressed state), a resistance value of 50Ω when 20 units of force is used, a resistance value of 15Ω when 5 units of force is used. Thus, if the amount of resistance change for a particular resistor is measured to be 50Ω, it can be determined that 5 units of force were used to press the “button” that corresponds to the particular resistor.

If process 800 detects any current flowing into one or more rows in the matrix of resistors, the one or more buttons pressed are identified at step 810. Continue with the above example and referring to FIG. 7, since column 1 is driven to the first voltage, and further it is detected that current flows into row 1, the button that corresponds to resistor R11 is identified as the button being pressed. Thus, by detecting if there is any current flowing into a row, it can be determined which particular button or buttons have been pressed.

At 814, process 800 determines if there are one or more remaining columns to be checked. If there are one or more remaining columns to be checked, then process 800 returns to step 803 to select the next column and repeating the above described process. Otherwise, process 800 terminates.

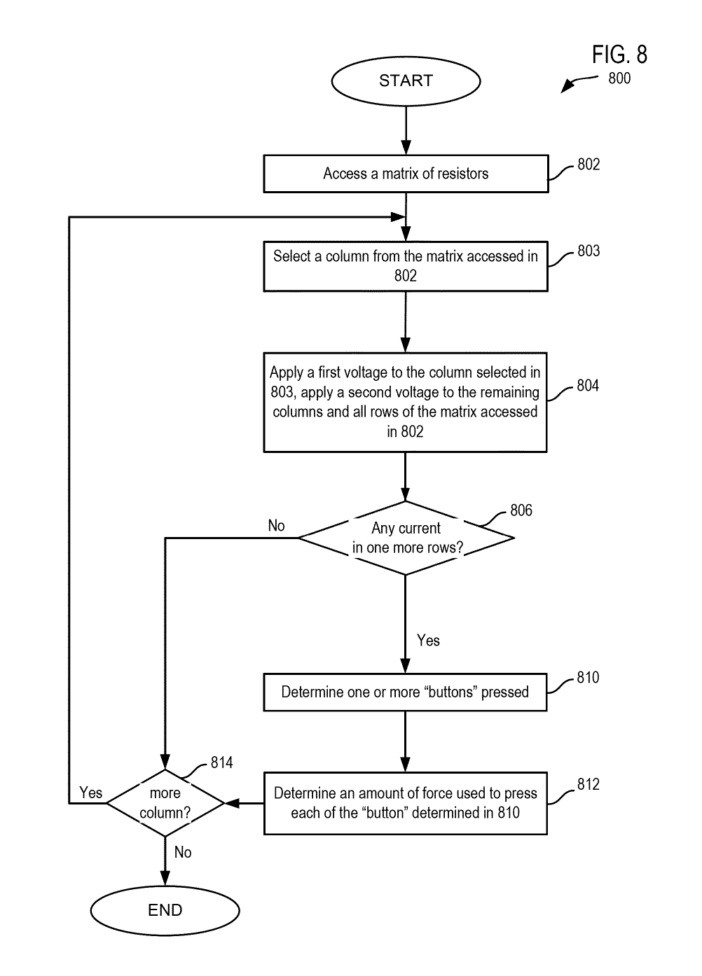

Pieces of fabric may be used to form articles of clothing or other display devices. Using fabric to create articles of clothing, accessories and other devices provides for an almost unlimited number of display designs. Fabric is available with a large number of different patterns and colors (or combination of patterns and colors). Fabric may also be manufactured from various types of materials including, but not limited to, cotton, wool, plastic, polyester, paper, and the like. FIGS. 9A-9C illustrate exemplary pieces of fabric that may be used to create an article of clothing according to an embodiment of the present technology.

FIG. 9A illustrates a substantially rectangular article of fabric 902 having a first side 904, a second side 906, a third side 908 and a fourth side 910. Each side of fabric 902 is shown having a straight edge. It is within the scope of the technology for one or more sides of fabric 902 to have a non-linear edge. Fabric 902 has an inner surface 912 and an exterior surface (not shown) opposite inner surface 912. Inner surface 912 of fabric 902 is intended to face the torso of a user wearing the article of clothing created by fabric 902, and the exterior surface is intended to face outward and be viewable to the user.

Fabric 902 may be implemented as an article of conductive fabric that includes a plurality of conductive threads 914. In one embodiment, the conductive threads 914 are implemented as parallel conductive threads as shown in FIG. 9A.

FIG. 9A also illustrates exemplary locations to implement a matrix of resistors 916 in fabric 902. Each resistor in the matrix of resistors 916 connects a unique row and column pair. Although not shown in FIG. 9A, fabric 902 may also include other electronics embedded therein for implementing the present technology as discussed above. These locations are exemplary only, and are not intended to limit the scope of the technology described herein.

FIG. 9B illustrates another article of fabric 920 that may be used to create an article of clothing according to an embodiment of the present technology. The article of fabric 920 has a substantially rectangular shape having a first side 922, a second side 924, a third side 926 and a fourth side 928. Each side of fabric 920 is shown having a straight edge. It is within the scope of the technology for one or more sides of the fabric to have a non-linear edge. Fabric 920 has an inner surface 930 and an exterior surface (not shown) opposite inner surface 930. Inner surface 930 of fabric 920 is intended to face the torso of a user wearing the article of clothing created by fabric 920. The exterior surface is intended to face outward and be viewable to the user.

Fabric 920 may be implemented as an article of conductive fabric that includes a plurality of conductive threads. In one embodiment, the plurality of conductive threads implemented in fabric 920 may include a first set of parallel conductive threads 932 and a second set of parallel conductive threads 934 perpendicular to the first set of conductive threads.

FIG. 9C illustrates another article of fabric 950 that may be used to create an article of clothing according to an embodiment of the present technology. The article of fabric 950 has a substantially rectangular shape having a first side 952, a second side 954, a third side 956 and fourth side 958. Each side of fabric 950 is shown having a straight edge. It is within the scope of the technology for one or more sides of the fabric to have a non-linear edge. The fabric 950 has an inner surface 960 and an exterior surface (not shown) opposite the inner surface 960. The inner surface 960 of the fabric 950 is intended to face the torso of a user wearing the article of clothing created by fabric 950. The exterior surface is intended to face outward and be viewable to the user.

Fabric 950 may be implemented as an article of conductive fabric that includes a plurality of conductive threads 964. In one embodiment, the conductive threads 964 are parallel conductive threads as shown in FIG. 9C.

The pieces of fabric shown in FIGS. 9A-9C are exemplary only, and are not intended to limit the scope of the technology described herein. These pieces of fabric may be cut into other shapes and sizes.

In a further aspect, a plurality of portions or “buttons” of a smart textile fabric may be simultaneously detected and used as inputs. Using the techniques described in U.S. Patent Application Publication No. 2009/0096640, entitled Keyboard with Plural Key Switch Matrices to Detect Ghosting, commonly assigned and hereby fully incorporated by reference, one may detect multiple simultaneous inputs to the smart fabric which maybe used as output to another display device or smart textile display.

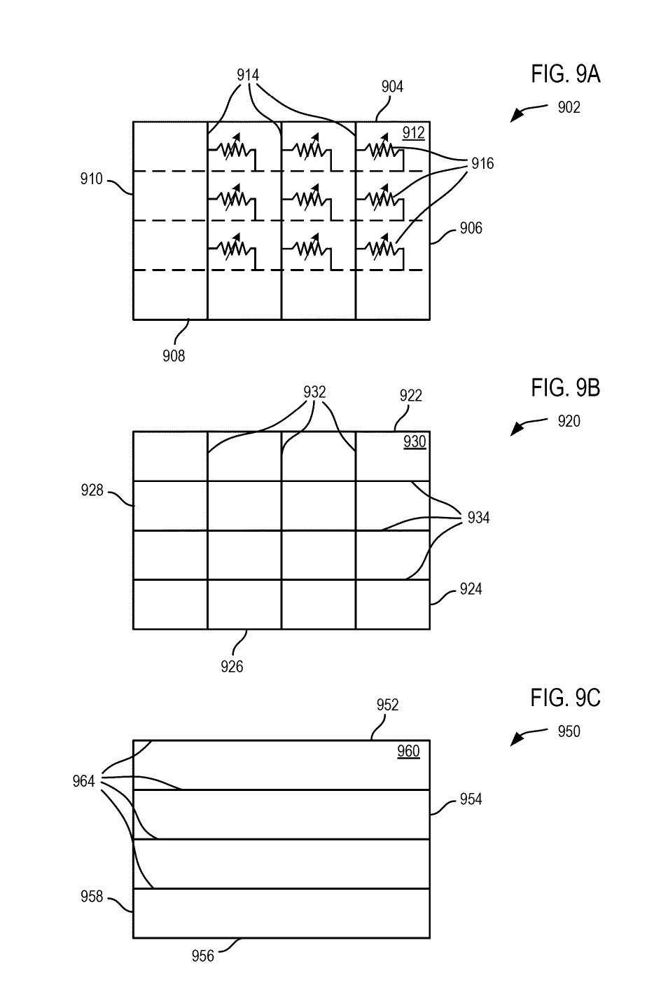

FIGS. 10A-10B illustrate exemplary articles of clothing according to an embodiment of the present technology. The exemplary articles of clothing of FIGS. 10A-10B may be created using one or more pieces of the fabric as illustrated in FIGS. 9A-9C.

FIG. 10A illustrates a jacket 1002 associated with a user. For example, jacket 1002 may be the second article of clothing 130 associated with the second user 132 as illustrated in FIG. 1. Referring to FIG. 10A, jacket 1002 displays a handprint 1004 on a right arm 1006 of the jacket. However, it is within the scope of the present technology to display the unique handprint anywhere on the jacket. For example, handprint 1004 may be displayed on a left arm 1008 of the jacket, on the chest 1010 of the jacket, or other places of the jacket.

Handprint 1004 that is displayed on jacket 1002 associated with the second user 132 may be a unique handprint of the first user 102 of the first article of clothing 104 as illustrated in FIG. 1. This is a unique way for the first user 102 to express his love and affection towards the second user 132 by transmitting personal and human information (e.g., the information identifying a unique handprint of the first user) to the second article of clothing 130 associated with the second user 132 and further displaying the information on the second article of clothing 130.

FIG. 10B illustrates a T-shirt 1020 associated with a user. For example, T-shirt 1020 may be the first article of clothing 104 associated with the first user 102 as illustrated in FIG. 1. Referring to FIG. 10B, T-shirt 1020 displays a flower symbol 1022 on the chest 1024 of the T-shirt. However, it is within the scope of the present technology to display flower 1022 anywhere on T-shirt 1020. For example, flower 1022 may be displayed on a left arm 1024 of the T-shirt, on the back of the T-shirt (not shown), or other places of T-shirt 1020.

Flower symbol 1022 may be displayed on T-shirt 1020 in response to information associated with the first user 102 that is detected and/or gathered by the T-shirt 1020, also known as the “self-triggering” as discussed above. For example, when information associated with the first user is detected and/or gathered which indicates that the first user 102 has walked 2000 steps, T-shirt 1020 may determine an action to be performed (e.g., displaying flower symbol 1022 on the T-shirt) according to one or more rules configured for the first article of clothing 102. The action determined to be performed may then be executed by T-shirt 1020 to display flower symbol 1022 on the T-shirt.

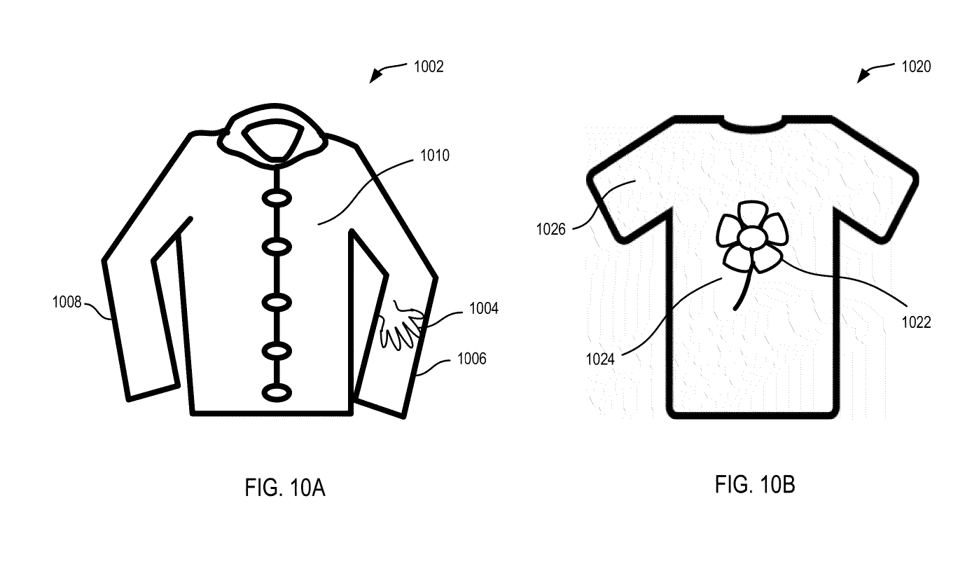

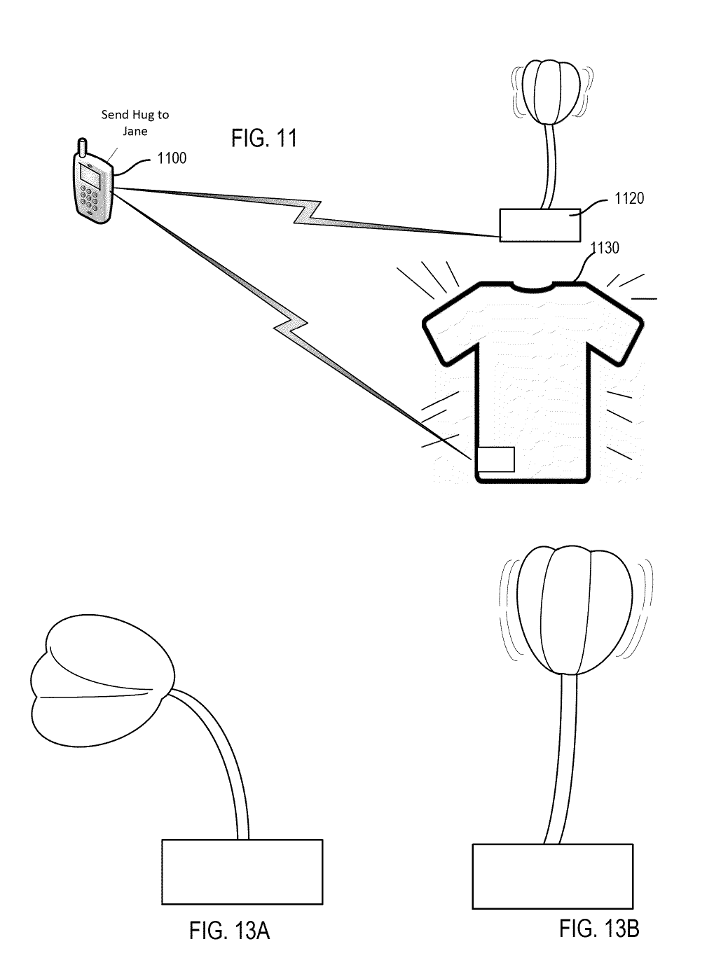

FIG. 11 illustrates another embodiment of the present technology whereby a source user of a mobile device activates an output device based on a text message. FIG. 12 illustrates a method associated with FIG. 11.

Referring to FIGS. 11 and 12, a user operating device 1100 may compose a text message “Send Hug to Jane” which is addressed to a target user “Jane” at a specific wireless address, in this case a cellular phone number. The number may be associated with one or more output devices, in this case a smart fabric flower garden 1120 and garment 1130. At step 1252, input information in the form of the message is received at the output device. At 1256, a set of one or more rules configured for the output device and associated with the user is evaluated based on the information detected and/or gathered in step 1252. Each target device 1120 1130 may have different output capabilities, including audio, visual and haptic capabilities. At step 1256, the capability and availability of each device is determined. At 1258, a determination is made whether one or more actions are to be performed based on the evaluation. Where the output device is a garden 1120, the text message may result in a garden vibrating, or springing to life when the message is received. In each such case, the message other input from the source user results in an output on the output device which is a representation of the source user input information. The representation is dependent on the information from the source user and the capabilities of the output device. Where the output device is a garment, the garment may glow or provide other haptic feedback according to the rule defined for the output device responsive to the input. At 1260, if one or more actions are determined in 1258, then the one or more actions are executed. At 1262, process 400 may output information as a result of executing the one or more actions in 1260. In one embodiment, processing may cause the output device to display the information.

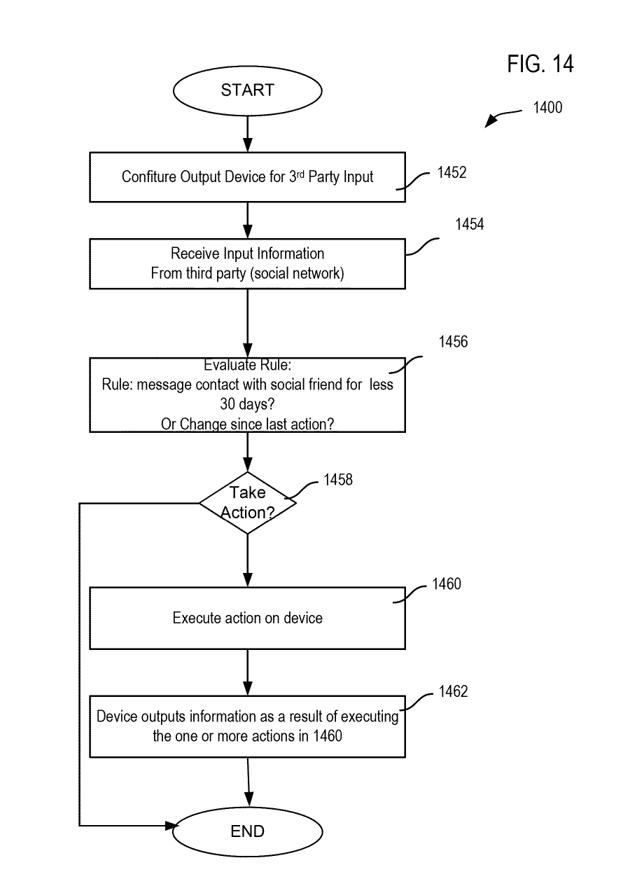

FIGS. 13A and 13b illustrate an output device comprising a smart textile flower in a wilted and upright position, respectively. FIG. 14 illustrates a method for responding to third party information. In this case, the display information may be associated with a social network. At step 1452, the output device is configured to receive information from a third party source. Unlike a direct input case where a source user provides information for a target user, the output device in the embodiment of FIGS. 13 and 14 may need to be configured to receive information from the third party. In one example, login credentials for a social network may be provided to the network and an application on the output device configured to receive information, or poll the social network for information, at regular intervals. This association ensures that the output device is associated with and provides information for the correct target user.

At 1454, input information in from the third party is received at the output device. At 1456, a set of one or more rules configured for the output device associated with the user is evaluated based on the information detected and/or gathered in step 1252 and the target device. In this example, the rule determines whether contact in the form of some message has occurred between the social network friend and a user within the last 30 days. If not, the rule specifies to execute a wilting of a flower display such as that shown in FIG. 13A. If so, the rule specifies that the flower should be upright as shown in FIG. 13B. The rule may also specify to change the state of the flower from that shown in 13A to that shown in 13B, and/or vibrate the flower. At 1458, a determination is made whether one or more actions are to be performed based on the evaluation. If the action is to be performed, the input may result in a flower vibrating, or springing to life when the information is received. At 1460, if one or more actions are determined in 1258, then the one or more actions are executed. At 1462, process 1400 may output information as a result of executing the one or more actions in 1460. In one embodiment, processing may cause the output device to display the information.

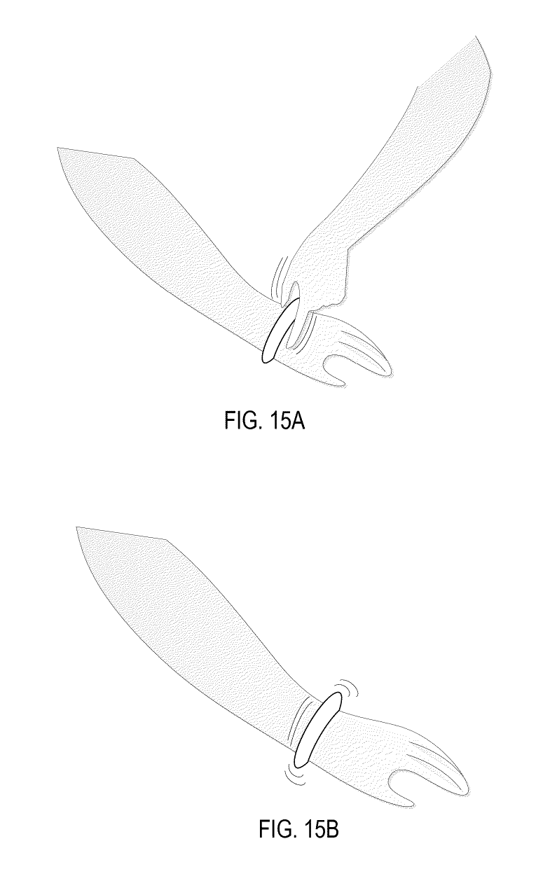

It should be understood that the input and output provided is not limited to visual feedback. FIGS. 15A and 15B illustrate the transmission of haptic feedback from one device to another. In the example shown in FIGS. 15A and 15B, a user 1500 squeezes a smart textile input/output device in the form of a bracelet 1502 comprised of a haptic feedback smart textile material. The information gathering component, information processing components and output components in devices 1502 and 1504 may be equivalent to those set forth above with respect to system 200 and may be incorporated into the smart textile input/output device or provided in a processing device attached to the smart textile input/output device. A correspondence between the input of the device 1502 and 1504 is established as described above, so that input on device 1502 is transmitted to device 1504. When user 1500 squeezes the bracelet 1502, the source user input at 1502 is transmitted to the device 1504 on the target user 1510. In this case, the squeeze from user 1500 on device 1502 is “felt” by user 1510 on device 1504.

It will be recognized that the input on any smart textile input/output device may be transmitted to another smart textile input/output device or another processing device, such as a computer, mobile phone, tablet or the like. Likewise, input from a processing device such as a computer, mobile phone, tablet or the like may be output to a smart textile input/output device.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for gathering and displaying information a of smart textiles output device, comprising:
gathering information associated with a target user to be displayed to the target user on the smart textile output device;
determining one or more actions to be performed based upon the information gathered, determining the one or more actions to be performed including:
determining a set of one or more rules configured for the target user, each rule specifying a condition to provide an output on the smart textile output device; and;
determining that a first rule from the set of rules is satisfied by the information gathered,
determining an available output action for the smart textile output device;
executing the output actions determined to be performed on the smart textile output device.

2. The method of claim 1, wherein the information gathered includes a direct input from a source user directed to a target user.

3. The method of claim 2, wherein the information gathered includes input from a smart textile input device.

4. The method of claim 2 wherein the information gathered includes at least one of: information identifying a handprint of the source user; information identifying an amount of force and a duration associated with a press by the source user via the first article of clothing; information identifying a drawing created by the source user via the smart textile input device; information transmitting a force from the source user to a target user.

5. The method of claim 2 wherein the information gathered includes receiving information from an input device in the form of a message from the source user to the target user for display by the smart textile output device.

6. The method of claim 5 wherein the step of determining a first rule includes determining that the message should result in an action on the smart textile output device and the step of determining an available output action includes determining an output action on the smart textile output device to display a representation of the message.

7. The method of claim 1, wherein the set of one or more rules configured for the smart textile output device is configurable by the first user.

8. The method of claim 1 wherein the information gathered includes information from a third party directed to a target user.

9. The method of claim 8 further including associated the smart textile output device with the target user and the third party such that information from the third party is directed to the smart textile output device.

10. A smart textile output device, comprising:
an information processing component including code determining an action to be performed responsive to display information received from an information source, the information processing component including instructions for a processing device to perform a method including determining the action to be performed based on at least one rule that is satisfied by the information received, wherein at least one action specified by the at least one rule is the action determined to be performed;
a communication component associated with output device, receiving information associated with the action determined to be performed from the information source; and
a smart textile output component responsive to the information processing component, executing the action determined to be performed if the action is determined to be performed.

11. The smart textile output device of claim 10 further including an information gathering component receiving direct input information of display information from a source user.

12. The smart textile output device of claim 11, wherein the information gathering component includes one or more sensors to detect and gather environmental information associated with the source user.

13. The smart textile output device of claim 12, wherein the information gathering component includes a detector to detect a static shape or a drawing in response to the first user pressing down on the device, the static shape including a handprint of the first user.

14. The smart textile output device of claim 11, wherein the detector includes an array of variable resistors with each resistor corresponding to a button and connecting a unique row and column pair, the detector configured to detect one or more buttons pressed and an amount of force used for each button pressed in response to the first user pressing down on the article of clothing.

15. The smart textile output device of claim 10, wherein the device includes at least one of: color-changing inks, a haptic feedback material, shape memory material, or a combination thereof.

16. The smart textile output device of claim 10 wherein the device is constructed in the form of a wearable garment for at least the target user.

17. The smart textile output device of claim 10 wherein the device is constructed in the form of a display article perceivable by and associated with a target user.

18. A smart textile input/output device formed into an article of clothing comprising:
a memory;
in information gathering component including a matrix of input elements incorporated into the article of clothing;
an output module; and
an information processor coupled to the memory, the processor is configured to:
detect information associated with a source user of the article of clothing responsive to source user input to a plurality of simultaneously depressed input elements on the information gathering component;
determine at least one action specified by the source user input when a condition associated with the input is satisfied by the information detected; and
execute the at least one action specified by the input including displaying information associated with a second user based on information received from the second user.

19. The smart textile input/output device of claim 18 further including an information gathering component receiving direct input information of display information from the source user.

20. The smart textile input/output device of claim 19, wherein the information gathering component includes one or more sensors to detect and gather environmental information associated with the source user.
